(19) United States
(12) Patent Application Publication
(10) Pub. No.: US 2012/0050746 A1
(43) Pub. Date: Mar. 1, 2012

(54) APPARATUS AND METHOD FOR INCREASING DEPTH RANGE AND SIGNAL TO NOISE RATIO IN FOURIER DOMAIN LOW COHERENCE INTERFEROMETRY

(76) Inventors: SHIVANI SHARMA, Indore (IN); KANWARPAL SINGH, Montreal (CA); GARGI SHARMA, Montreal (CA)

(21) Appl. No.: 12/870,825

(22) Filed: Aug. 29, 2010

(51) Int. Cl. G01B 9/02

(52) U.S. Cl. 356/479

(57) ABSTRACT

Apparatus, method and data processing for increasing the depth range and signal to noise ratio (SNR) in Fourier domain low coherence interferometry (FD LCI) and in Fourier domain optical coherence tomography (FD OCT) using a 2 dimensional (2D) detector array is provided. The depth range and the noise of the FD LCI and FD OCT depend on the number of pixels in the detector that are used for imaging. As the depth range is proportional and the noise is inversely proportional to the number of pixels, the use of increased number of pixels of a 2D detector array increases the depth range and the signal to noise ratio (SNR) many fold.

### BACKGROUND

In the recent past optical coherence tomography (OCT) [D. Huang, E. A. Swanson, C. P. Lin, J. S. Schuman, W. G. Stinson, W. Chang, M. R. Hee, T. Flotte, K. Gregory, C. A. Puliafito, and et al., “Optical coherence tomography,” Science (New York, N.Y. 254, 1178-1181 (1991)] which is based on the principle of low coherence interferometry (LCI) has emerged as an imaging technique with axial resolution of few microns. This technique has been proven very useful in imaging biological samples and especially in ophthalmology for imaging different layers of retina and cornea because of its micron resolution and non invasive nature. Presently there exists two variants of OCT, time domain optical coherence tomography (TD OCT) and Spectral domain optical coherence tomography (SD OCT). In TD OCT system the reference arm is scanned axially which produces a modulation in the signal at the detector and the envelope of the modulation gives the axial profile of the sample. The other variant SD OCT can further be divided into two branches, Fourier domain OCT (FD OCT) and Swept source OCT (SS OCT). In FD OCT a broadband light source is used as an illuminating source for the sample and the reference. The reflected signal from the sample and the reference is combined using some beam combining optics and this combined signal is dispersed over a 1-dimensional (1D) linear detector array using a dispersive element which can be a grating or a prism. The signal acquired from the 1D linear detector is Fourier transformed to obtain the axial scan of the sample. In SS OCT a fast wavelength swapping laser source is used along with a single detector (at place of 1D linear detector as used in FD OCT). The signal obtained at the detector for different wavelengths is then used to construct the complete spectrum which is then Fourier transformed to obtain the axial scan of the sample. Because of the increased SNR and increased speed, SD OCT techniques are preferred over TD OCT techniques [R. Leitgeb, C. Hitzenberger, and A. Fercher, “Performance of fourier domain vs. time domain optical coherence tomography,” Optics express 11, 889-894 (2003)].

Out of the above listed techniques, FD OCT is preferred most because of its high SNR. However imaging long depths is still a challenge in FD OCT because of the limited depth range and low SNR at longer depth ranges. The depth range is proportional and SNR is inversely proportional to the number of pixels from the 1D linear detector array that are used to image the dispersed spectrum. In typical FD OCT systems linear detector with pixels more than 2000 is used to achieve a depth range of 1-2 mm. Such systems can not be used to image for example the complete anterior chamber of the eye which is typically 3.5 mm.

Different variants of the FD OCT have been proposed to increase the depth range. In FD OCT the obtained A-Scan contains the mirror images of the sample. To remove mirror images in the A-Scan different techniques based on phase shifted algorithms have been proposed [R. A. Leitgeb, C. K. Hitzenberger, A. F. Fercher, and T. Bajraszewski, “Phase-shifting algorithm to achieve high-speed long-depth-range probing by frequency-domain optical coherence tomography,” Optics letters 28, 2201-2203 (2003)]. With the removal of the mirror image from the A-Scan, the depth range is doubled. A different method based on pixel shifting has been proposed previously to increase the depth range by a factor of two [Z. Wang, Z. Yuan, H. Wang, and Y. Pan, “Increasing the imaging depth of spectral-domain OCT by using interpixel shift technique,” Optics express 14, 7014-7023 (2006)]. Phase shifting technique and pixel shifting technique only doubles the depth range. With these techniques one can only reach to the depth range of few millimeters. In one of the techniques multiple modulating reference surfaces are used to obtain the depth profile of the sample [U.S. Pat. No. 7,355,716, B2]. But the use of multiple modulators makes the system complex and expensive.

Therefore, there is a need of a cost effective and simple method which can provide greater depth range in axial direction.

### BRIEF DESCRIPTION OF THE DRAWINGS

FIG. 1 Schematic of a conventional FD-LCI system.

FIG. 2 Schematic of an embodiment showing the use of a 2D detector array to increase the depth range according to the present invention.

FIG. 3a Schematic of an embodiment showing the use of a Fabry-Perot Etalon to maintain high signal to noise ratio at larger depths.

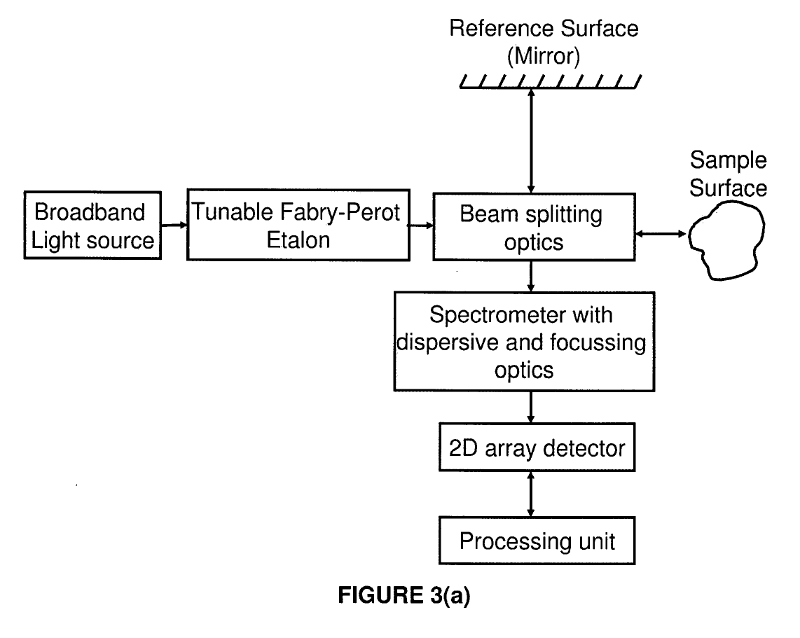

FIG. 3b Schematic of an embodiment showing the use of a Fabry-Perot Etalon and reference surface mounted on piezzo for removal of the mirror image.

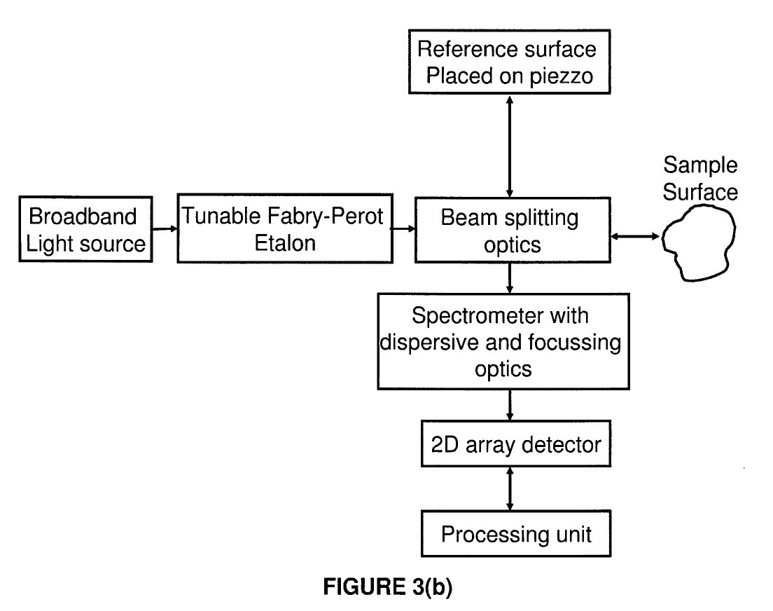

FIG. 4 is a schematic in which the arrangement of pixels in a 2D detector array is shown.

FIG. 5 is a schematic to show the use of a 1D detector in FD-LCI

FIG. 6 Schematic to show the use of a 2D detector array in FD-LCI

FIG. 7 Schematic of a 2D detector array whose lines are aligned with the diffraction plane.

FIG. 8 Schematics of a 2D detector array whose lines are at an angle with the diffraction plane.

FIG. 9 A-Scans at different optical path differences for 1 line and 5 lines of a 2D detector array are shown.

### SUMMARY

The present invention relates to the increase of depth range and SNR in FD LCI and FD OCT with the use of 2D detector array. As described elsewhere in literature [R. Leitgeb, C. Hitzenberger, and A. Fercher, “Performance of fourier domain vs. time domain optical coherence tomography,” Optics express 11, 889-894 (2003)], the depth range of FD LCI and FD OCT is proportional whereas the SNR is inversely proportional to the number of pixels used in the 1D detector array. This would mean that the depth range and SNR can be improved by increasing the number of pixels in the 1D detector array. N times increase in the number of pixels in the detector would increase the depth range by N times and improve the SNR by many fold. In present FD LCI and FD OCT variants we see the use of 1D detectors with pixels ranging from 512 to 4096 which typically gives the depth range of 0.5 mm to 4 mm. But for the depth range of 10 mm or more one would need a 1D detector with pixels close to 10000 or more. Such kind of 1D detectors are not available in the market and are difficult to fabricate.

The present invention makes use of the large number of pixels available in the 2D detector array to increase the depth range and SNR. A typical 2D detector array can have M×N number of pixels where M is the number of 1D array or 1D lines of pixels, each of which has N number of pixels. The factor M can typically be about 2000 to 4000 and thus with the use of M number of 1D detector arrays, a gain of M times would be obtained in the imaging depth range with improved SNR. This means that if all the arrays or lines of the 2D detector array are used then theoretically the depth range can be increased by up to 4000 times. In reality it is difficult to increase the depth range and SNR by this much amount because of the factors described later in this invention.

The present invention describes an optical system for Fourier domain low coherence interferometry and Fourier domain low coherence tomography that consist of a optical source, optical detector and optical transmission media between the optical source, optical detector and sample.

In one embodiment, the optical source is a broadband light source followed by beam splitting optics that splits the light signal from the broadband light source into two parts one for the sample and other for the reference surface. The optical detector consists of a dispersive element, focusing optics and a two dimensional (2D) detector array connected to the signal processing device.

In other embodiments the optical source is followed by polarizing optics as optical transmission media. The optical source itself can be polarized or a polarizer can be used to obtain polarized light from the source.

In yet another embodiment a periodic optical filter or a combination of periodic optical filters can be used between the optical source and the optical detector. In summary, the present invention describes the use of 2D detector array to increase the SNR and imaging depth in FD LCI and FD OCT systems. This increased depth range and increased SNR can be very useful in imaging and diagnostic techniques used for medical and non medical applications.

### DETAILED DESCRIPTION

### Theory

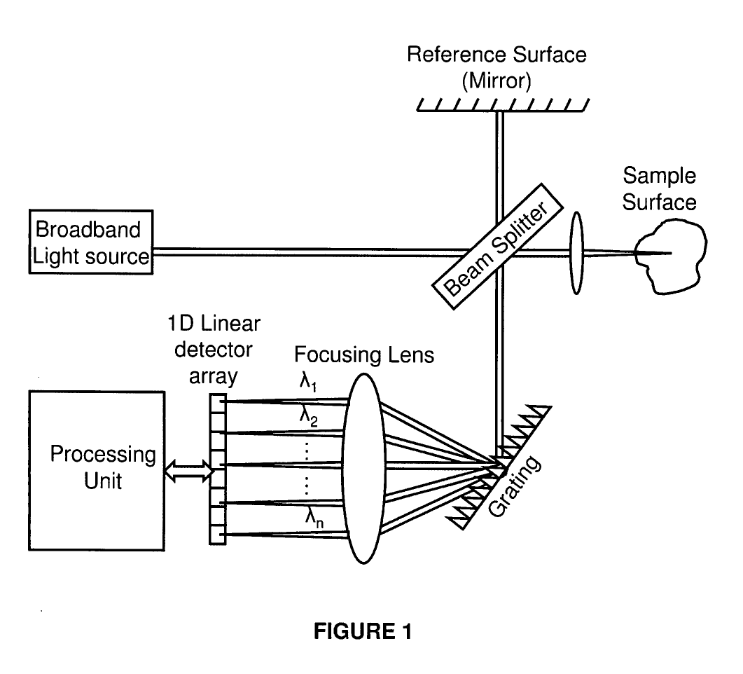

FIG. 1 shows the schematic of a conventional FD LCI optical system. The signal from the optical source is splitted into two parts using a beam splitter. One part goes towards the reference arm and the other part towards the sample. The signal reflected from the sample and the reference arms are combined at the beam splitter which further split it into two parts. One part travels back towards the optical source and the other part towards a dispersion grating. This dispersion grating can be transmission grating or a reflecting grating but for illustration purposes we are showing a reflecting grating. The signal that is reflected from the grating is focused on a linear 1D detector array using a spherical lens. The signal reflected from the sample surface and the reference surface interfere together and produce an interference pattern at the 1D detector array. The profile of the intensity pattern at the 1D detector array is give by the following equation.

I(λ)=Iᵣ(λ)+Iₛ(λ)+2\sqrt{Iᵣ(λ)Iₛ(λ)}Cos(φ) (1)

where Iᵣ is the intensity of the signal from the reference surface, Iₛ is the intensity of the signal from the sample surface, λ is the wavelength and go is a phase shift. The phase shift depends on the optical path difference between the sample and the reference surface, the interfering wavelength and a constant phase shift which could be because of the different reflective properties of the sample and the reference. The total phase shift is given by

$$ϕ = {ϕ}_{0} + \frac{4 π}{λ} Δ z \qquad ( 2 )$$

where Δz is the optical path difference between the sample and the reference surface, λ is the wavelength and φ₀ a constant phase shift.

As the source used is a broadband source with wavelengths ranging from λc−Δλ/2 to λc+Δλ/2 with λc as the central wavelength and Δλ as the bandwidth, the phase difference is different for different wavelengths for a particular optical path difference. Because of the presence of the cosine term in EQ. 1, the dependence of the phase on the wavelength produces a modulation in the intensity recorded with the 1D detector array. The frequency of this modulation is given by the rate of change of phase with wavelength and is given by

$$\frac{\partial ϕ}{\partial λ} = - \frac{4 π}{{λ}^{2}} Δ z \qquad ( 3 )$$

From this equation it can be seen that the frequency of the modulation or the fringes is directly proportional to the optical path difference which means that the maximum optical path difference or the depth range that can be measure with such a system will depend on the maximum frequency that can be measured.

If a 1D detector array with N number of pixels is used in the optical system than according the Nyquist criteria the maximum frequency that can be measured will be half of N which consequently limits the depth range. Thus the maximum depth range that can be obtained with a system using ID detector with N pixels will be γ times N/2 where γ is a constant of proportionality.

A simple way to increase the depth range would be to increase the number of pixels in the ID detector array. But increasing the number of the pixels after a certain limit is not feasible. So we propose a method by which we can use the pixels available in a 2D detector array which are eventually used to generate a 1D array of the signal spectrum.

### Use of 2D Detector Array to Increase the Depth Range and SNR

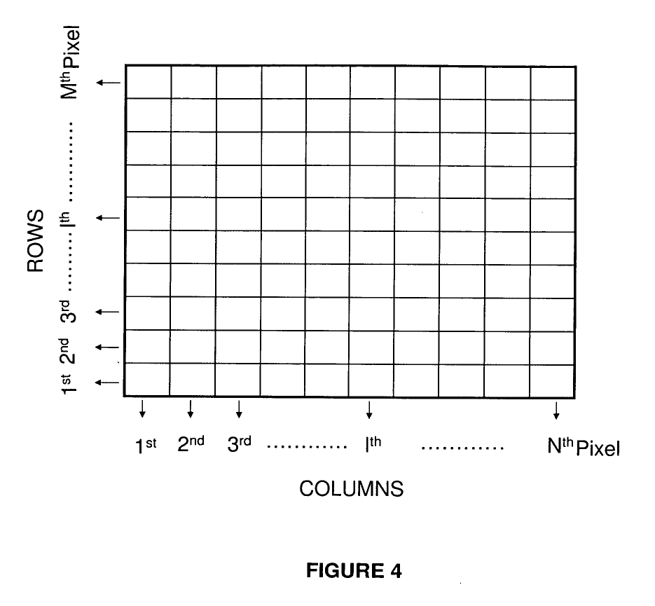

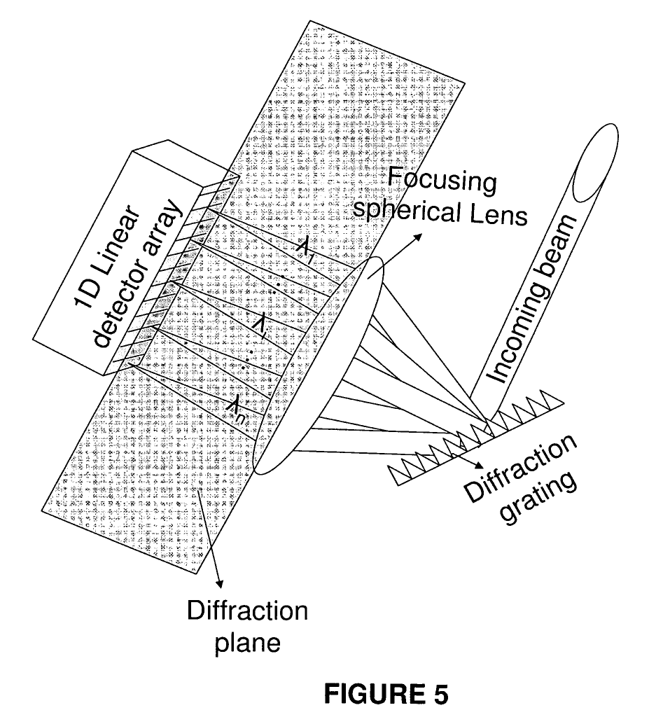

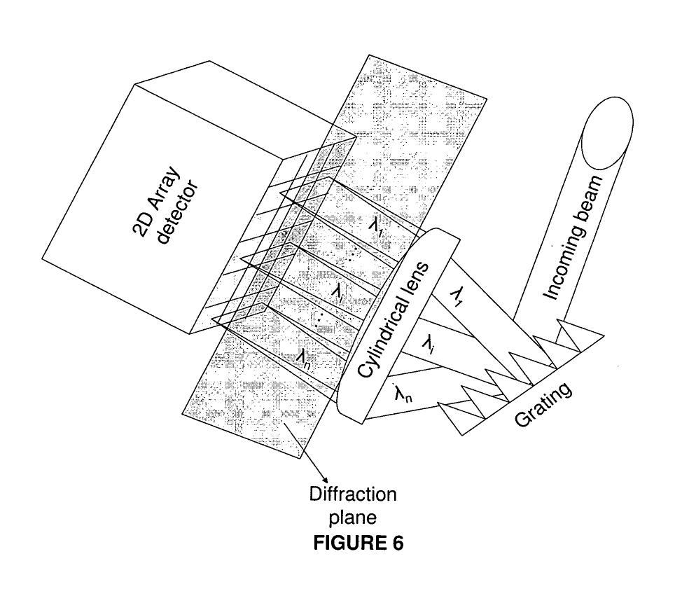

A 2D detector array has M×N number of pixels where M is the number of detector lines each of which contains N number of pixels. These pixels are arranged in a line and column architecture as shown in FIG. 4). In normal FD LCI or FD OCT systems, the pixels in the line of the 1D detector are aligned in the plane of the diffraction after the grating such that different wavelengths are focused at different pixels as shown in the FIG. 5). Diffraction plane is a plane that contains the incident beam, diffracted beam and a perpendicular to the face of the grating. Since a spherical lens is used after the grating to focus the spectral components on to the ID detector array, the spectral components or different wavelengths are focused in a circular spot of finite size. In FIG. 6) is shown the use of a 2D detector array whose 1D lines of pixels are aligned parallel to the diffraction plane. At place of spherical lens a cylindrical lens is used to focus the spectral components. Since a cylindrical lens focuses only in one direction, the use of cylindrical lens produces a focused line (at place of circular spot as in case of spherical lens) of spectral components on the different columns of the 2D detector array. The advantage of using a cylindrical lens is that the signal is distributed over all the pixels of the 2D detector array while still focusing the wavelength components for optimum spectral resolution. This way each 1D line of the 2D detector array receives the same information about the spectrum signal. This is because each pixel in the i^{th} column receives the same wavelength. But if the 2 D detector is rotated around the diffraction plane with diffracted beam propagation direction as the axis of rotation then the wavelength falling on the pixels of the i^{th} column of the 2D detector array would be different. This way if a 1D spectrum is reconstructed from the 2D detector array such that increasing wavelengths are arranged sequentially, the reconstructed spectrum would be containing larger number of pixels and thus giving larger depth range and higher SNR. The exact procedure to reconstruct the 1D spectrum from the 2D detector array is explained further.

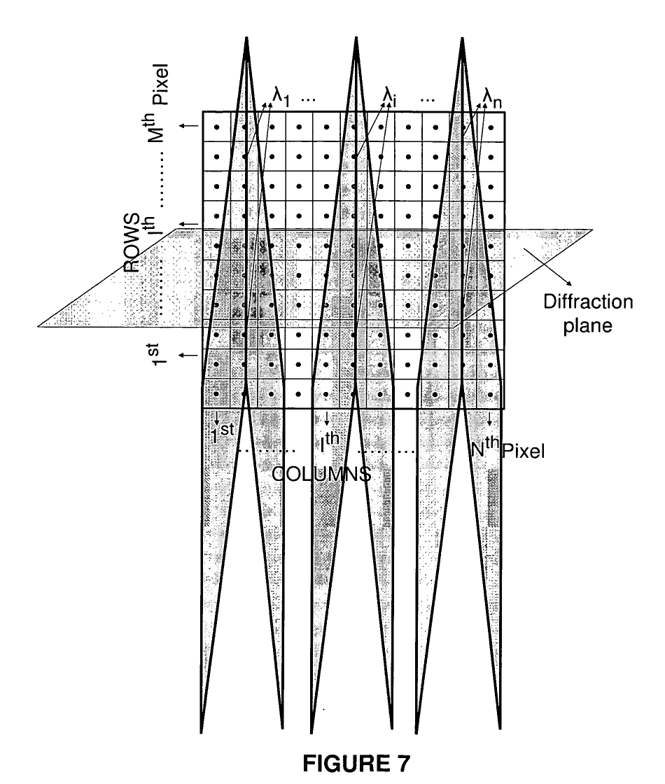

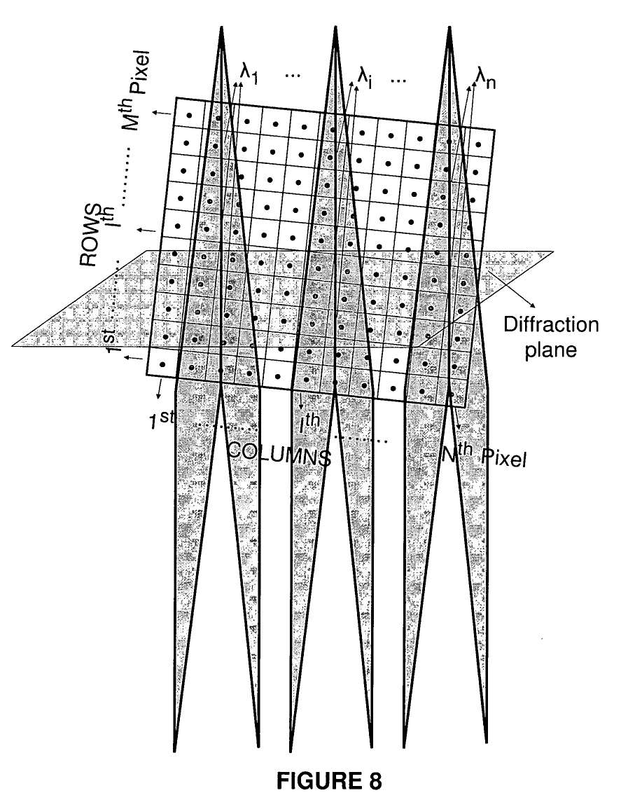

For example a 2D detector array has M×N number of pixels where M is the number of lines and N number of columns of pixels. A pixel here is denoted the by the notation P(x,y) where x is the coordinate of the line number and y is the coordinate of the column number. If we want to use all the M number of lines of the 2D detector array such that the depth range can be increased by M times, then the 2D detector should be rotated (towards the direction of increasing wavelength) around the diffraction plane with diffracted beam propagation direction as the axis of rotation. After rotation, the center of i^{th} column of the M^{th} line should not cross the center of the (i+1)^{th} column of the 1st line but should be as close as it can be. This scheme of rotation is shown in FIG. 7) and FIG. 8). Initially in FIG. 7) the 2D detector array is aligned in such a way that its 1D pixel lines are aligned parallel to the diffraction plane. This way different wavelengths are focused in different columns of the 2D detector array and each column receives the same band of wavelengths. For example in FIG. 7), λᵢ is shown to be focused is column 2, λᵢ in i^{th} column and λₙ in the (N−1)^{th} column. In FIG. 8) the 2D detector has been rotated by an angel such that the center of the focused 2 line passes through center of the pixel P(M,2) but is just to the left of the center of the pixel P(1,3). This way different pixels of the i^{th} column which were receiving the same band of wavelengths before rotation will now receive a different band of wavelengths after rotation. A 1D array for the spectrum signal can now be generated by first taking the signal from the M lines of 1st column followed by the signal from the 2^{nd} column, followed by the signal from the 3^{rd} column and like this up to N^{th} column. For example the 1D signal generated for the schematic shown in FIG. 8) will be

### P(1,1), P(2,1), . . . , P(M,1), P(1,2), P(2,2), . . . , P(M,2), . . . P(x,y), . . . , P(1,N), P(2,N), . . . , P(M,N)

where x is the coordinate of the line number and y is the coordinate of the column number.

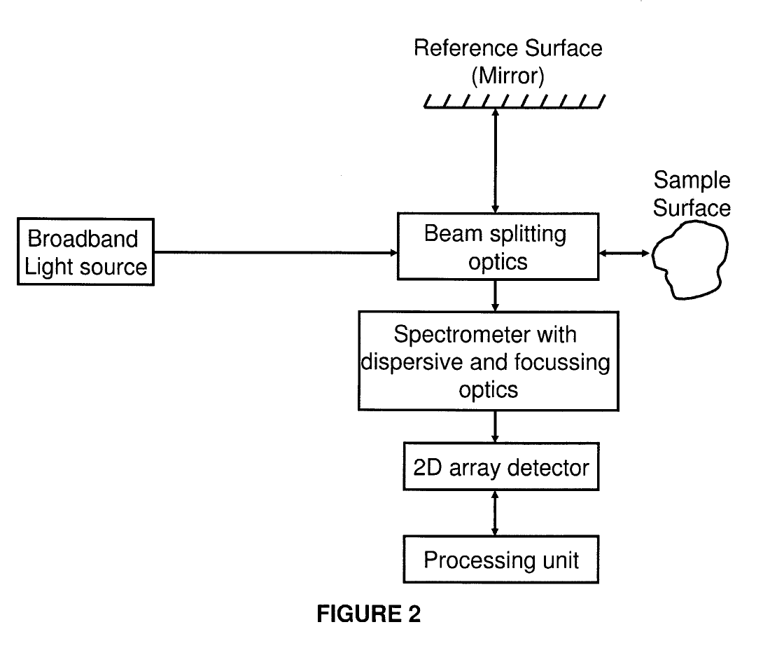

This way the complete spectrum is now imaged by M×N number of pixels using 2D detector which would have been imaged by just N number of pixels if one was using 1D detector. This increase in the number of pixels by M times leads to a theoretical M times increase in the depth range and many fold increase in the SNR. In FIG. 2) is shown an exemplary embodiment where light from a broadband source is splitted into two parts using beam splitting optics. One part of the splitted beam goes to the sample and another part to the reference surface. The reference surface used in the present embodiment is a mirror. A part of the signal reflected from the mirror and the sample is directed towards the spectrometer unit which usually has a dispersive element for example a grating, followed by the focusing optics. A 2D detector array is used to collect the signal from the spectrometer. A 2D detector array having M×N number of pixels would give theoretically a M fold increase in the depth range over the depth range that can be obtained with 1D detector array having N number of pixels. But because of the finite size of the pixels [T. Bajraszewski, M. Wojtkowski, M. Szkulmowski, A. Szkulmowska, R. Huber, and A. Kowalczyk, “Improved spectral optical coherence tomography using optical frequency comb,” Optics express 16, 4163-4176 (2008)] the SNR reduces for larger depth ranges and the theoretical M times increase in the depth range can not be achieved. Still a considerable amount of gain can be achieved in the depth range using a periodic spectral filter for example a Fabry-Perot Etalon. The use of periodic optical filters has been explained in detail in U.S. Pat. No. 7,602,500 B2.

An exemplary embodiment is shown in FIG. (3a) where a tunable Fabry-Perot Etalon is used just after the light source. For demonstration purposes we have shown the use of a Fabry-Perot Etalon but in fact any device that produces very narrow bands of frequencies can be used and such a device can also be used elsewhere in the system. The use of such devices has been reported previously [U.S. Pat. No. 7,602,500 B2] to increase the SNR at larger depth ranges.

In FIG. (3b) we are showing an exemplary embodiment where the reference surface is placed on a modulator for example a piezzo. The piezzo is moved to obtain 5 phase shifted spectrum signal and these spectrum signals are used to remove the mirror image in the A-Scan. We have shown the use of the piezzo modulator for exemplary purposes only but other phase shifting techniques can also be used to remove the mirror image from the A-Scan. The removal of the mirror image from the A-Scan makes it possible to use the other half of the fast Fourier transform (FFT) signal for imaging.

### Example

Various embodiments presented in this invention were verified experimentally with the experiment explained here.

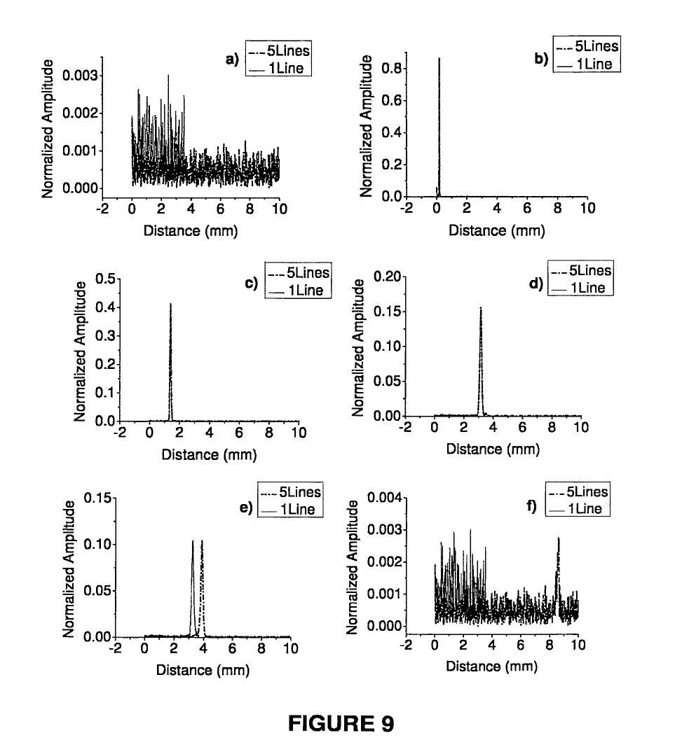

A 2D CCD camera with 400 lines and 640 columns of pixels per line was used. If a 1D detector would have been used then according to Nyquist criteria the maximum frequency that could be measured using 640 pixels would be 320. Consequently the maximum depth range that could have been measured would be 320 multiplied with the depth range per pixels which in our case was 11.1532 micron per pixel. Accordingly the depth range that could have been obtained with 640 pixels of a 1D detector would be (320×11.1532) 3.569 mm. We actually used the 5 lines of the 2D CCD by rotating it around the diffraction plane and then generating a 1D array of the spectrum signal according to the scheme explained previously. Using this technique we imaged the spectrum with 3200 pixels. The A-scans for different optical path differences obtained with 1 line and 5 lines are shown in FIG. 9(a-f)). The Fast Fourier Transform (FFT) peak signal in the A-Scan corresponds to the optical path difference (OPD) between the reference surface and the sample surface. For this experiment mirrors were used as sample surface and reference surface. The amplitude of the A-scan was normalized with the maximum amplitude of the FFT peak obtained close to zero optical path difference.

In FIG. (9a) the noise level in the A-Scan for 1 line and 5 lines is shown. The standard deviation (SD) of the normalized noise for 1 line and 5 lines was found to be 5.67×10⁻⁴ and 2.36×10⁻⁴ respectively. This shows a gain of about 2.4 times in the SNR using 5 lines. It can also be seen from the FIG. 9(b-f)) that with the increased OPD the FFT peak signal moves away from the zero with a decrease in the amplitude. This decrease in the amplitude is because of the finite size of the detector pixel. Until the OPD of 3.569 mm the A-Scans obtained from 1 line and 5 lines looks similar. But as the OPD is increased beyond 3.569 mm, because of the Nyquist criteria the FFT peak in the 1 line A-Scan starts to travel back towards the zero OPD position. This phenomenon is also called the frequency roll off. Whereas the FFT peak signal in the A-Scan of the signal obtained from 5 lines does not travel back after 3.569 mm but keeps moving towards larger depth ranges for increased OPD. The maximum depth range that we could obtain experimentally using 5 lines or 3200 pixels of the 2D CCD camera was about 8.6 mm for a SNR of 10. Theoretically using 3200 pixels we should have been able to obtain a depth range of 35.69 mm. But because of the finite size of the pixel, the SNR decreases for larger depth range which makes it difficult to recognize the signal in the presence of the noise. In our case the SNR decreased to about 10 for a depth range of 8.6 mm.

To verify one the embodiment that removes the mirror images out of the Fourier transformed data we obtained 5 phase shifted spectrum and reconstructed a complex valued spectrum which on Fourier transform produced an A-Scan free from mirror image. This way we gained another 8.6 mm of depth range which gave a total depth range of 17.2 mm for the tested exemplary system.

What is claimed:

1. An imaging system which comprises
a broad band light source
a light splitting optics that splits the light into sample light and reference light
a sample arm with optics that receives the light, direct it towards the sample, collects the light from the sample and then direct it back towards the detector.
a reference arm that receives the light, direct it towards the reference surface, collects the light from the reference surface and then direct it back towards the detector.
a detector system that comprises of diffraction optics, focusing optics and a 2D detector array at an angle to the diffraction plane to receive the light from the sample and the reference surfaces.
a processing unit that receives the signal from the detector system and process the signal to give higher depth range and higher SNR.

2. An imaging system of claim 1 where the light reaching to the detector is periodic which is obtained either by making the light source periodic itself or by placing a system in the signal path between the light source and the detector.

3. An imaging system of the claim 2 wherein the light reaching the detector is modulated either by modulating the light source itself or by putting a modulator in the signal path between the light source and the detector.

4. An imaging system of the claim 3 wherein the light used is polarized.

5. An imaging system of the claim 4 built using optical fibers for signal guidance.

6. An imaging system of the claim 5 wherein a circulator is used for signal guidance.

7. An imaging system of claim 1 that uses multiple 2D detectors in order to obtain tomographic profile of the sample.

8. An imaging system of claim 1 with scanning optics in the sample arm.

9. An imaging system of claim 1 with dispersion compensation and beam shaping optics between the light source and the detector.
